(19) United States
(12) Patent Application Publication
(10) Pub. No.: US 2013/0114579 A1
(43) Pub. Date: May 9, 2013

(54) DATA TRANSMISSION METHOD, RELATED BASE STATION AND USER EQUIPMENT

(71) Applicant: Dragan Vujcic, Limours (FR)

(72) Inventor: Dragan Vujcic, Limours (FR)

(73) Assignee: LG ELECTRONICS INC., Seoul (KR)

(21) Appl. No.: 13/809,796

(22) PCT Filed: Jun. 17, 2011
(86) PCT No.: PCT/KR2011/004438

§ 371 Date: Jan. 11, 2013

Related U.S. Application Data
(60) Provisional application No. 61/363,617, filed on Jul. 12, 2010.

(51) Int. Cl. H04W 72/04

(52) U.S. Cl. CPC H04W 72/0453
USPC 370/336

(57) ABSTRACT

Method for transmitting data between a base station (310) of a radiocommunication network and a User Equipment (320), UE, by using multiple Component Carriers, CCs. The method comprising: transmitting, on a Primary CC, PCC, an activation/deactivation command to activate/deactivate a Secondary CC, SCC, from the base station to the UE; and after transmission of said activation/deactivation command, delaying transmission of data on the SCC between the base station and the UE by a predetermined delay, the predetermined delay being set to include a time period needed for a UE to perform an RF retuning as a result of an activation/deactivation command.

### TECHNICAL FIELD

The present invention relates to carrier aggregation management in a radiocommunication system.

### BACKGROUND ART

Many different types of radiocommunication systems (i.e. networks) exist. GSM, UMTS, LTE and LTE-advanced are non-limiting examples of such radiocommunication systems.

FIG. 1 is a block diagram showing a radiocommunication system. This may be a network structure of a 3rd generation partnership project (3GPP) long term evolution (LTE)/LTE-advanced (LTE-A). An E-UTRAN (Evolved-UMTS Terrestrial Radio Access Network) includes at least one base station (BS) 20 providing a user plane and a control plane towards a user equipment (UE) 10. The UE can be fixed or mobile and can be referred to as another terminology, such as a MS (Mobile Station), a UT (User Terminal), a SS (Subscriber Station), MT (mobile terminal), a wireless device, or the like. The BS 20 may be a fixed station that communicates with the UE 10 and can be referred to as another terminology, such as an e-NB (evolved-NodeB), a BTS (Base Transceiver System), an access point, or the like. There are one or more cells within the coverage of the BS 20. Interfaces for transmitting user data or control data can be used between BSs 20 (in the present document, the term “data” is used as a synonymous for “traffic” and does not imply any limitation as to the nature of such data, which can refer e.g. to user traffic or control traffic i.e. signaling). The BSs 20 are interconnected with each other by means of an X2 interface. The BSs 20 are also connected by means of the S1 interface to the EPC (Evolved Packet Core). They may interface to the aGW (E-UTRAN Access Gateway) via the S1. In the example shown in FIG. 1, the BSs 20 are more specifically connected to the MME (Mobility Management Entity) by means of the S1-MME and to the Serving Gateway (S-GW) by means of the S1-U. The S1 interface supports a many-to-many relation between MME/S-GW 30 and the BS 20.

Hereinafter, downlink means communication from the BS 20 to the UE 10, and uplink means communication from the UE 10 to the BS 20. In downlink, a transmitter may be a part of the BS 20 and a receiver may be a part of the UE 10. In uplink, a transmitter may be a part of the UE 20 and a receiver may be a part of the BS 20.

FIG. 2 gives an overview of the E-UTRAN architecture where:
eNB, aGW Control Plane and aGW User Plane boxes depict the logical nodes;
The boxes within the eNB box from RRC to Inter Cell RRM as well as the boxes SAE Bearer Control and MM Entity within the aGW Control Plane box depict the functional entities of the control plane; and
The boxes within the eNB box from PHY to RLC depict the functional entities of the user plane.

Functions agreed to be hosted by the eNB are: Selection of aGW at attachment; Routing towards aGW at RRC activation; Scheduling and transmission of paging messages; Scheduling and transmission of BCCH information; Dynamic allocation of resources to UEs in both uplink and downlink; The configuration and provision of eNB measurements; Radio Bearer Control; Radio Admission Control; Connection Mobility Control in LTE_ACTIVE state.

Functions agreed to be hosted by the aGW are: Paging origination; LTE_IDLE state management; Ciphering of the user plane; PDCP; SAE Bearer Control; Ciphering and integrity protection of NAS signaling.

FIG. 3 shows the user-plane protocol stack for E-UTRAN.

RLC (Radio Link Control) and MAC (Medium Access Control) sublayers (terminated in eNB on the network side) perform the functions such as Scheduling, ARQ (automatic repeat request) and HARQ (hybrid automatic repeat request).

PDCP (Packet Data Convergence Protocol) sublayer (terminated in aGW on the network side) performs for the user plane functions such as Header Compression, Integrity Protection, Ciphering.

FIG. 4 shows the control-plane protocol stack for E-UTRAN. The following working assumptions apply.

RLC and MAC sublayers (terminated in eNB on the network side) perform the same functions as for the user plane;

RRC (Radio Resource Control) (terminated in eNB on the network side) performs the functions such as: Broadcast; Paging; RRC connection management; RB control; Mobility functions; UE measurement reporting and control.

PDCP sublayer (terminated in aGW on the network side) performs for the control plane the functions such as: Integrity Protection; Ciphering.

NAS (terminated in aGW on the network side) performs among other things: SAE bearer management; Authentication; Idle mode mobility handling; Paging origination in LTE_IDLE; Security control for the signaling between aGW and UE, and for the user plane.

RRC uses the following states:

1. RRC_IDLE:

UE specific DRX configured by NAS; Broadcast of system information; Paging; Cell re-selection mobility; The UE shall have been allocated an id which uniquely identifies the UE in a tracking area; No RRC context stored in the eNB.

2. RRC_CONNECTED:

UE has an E-UTRAN-RRC connection; UE has context in E-UTRAN; E-UTRAN knows the cell which the UE belongs to; Network can transmit and/or receive data to/from UE; Network controlled mobility (handover); Neighbour cell measurements; At RLC/MAC level: UE can transmit and/or receive data to/from network; UE also reports channel quality information and feedback information to eNB.

The network signals UE specific paging DRX (Discontinuous Reception) cycle. In RRC Idle mode, UE monitors a paging at a specific paging occasion of every UE specific paging DRX cycle. The paging occasion is a time interval where a paging is transmitted. UE has its own paging occasion. A paging message is transmitted over all cells belonging to the same tracking area. If UE moves from a tracking area to another tracking area, UE will send a tracking area update message to the network to update its location.

A physical channel transfers signaling and data between UE L1 and eNB L1. As shown in FIG. 5, the physical channel transfers them with a radio resource which consists of one or more sub-carriers in frequency and one more symbols in time. 6 or 7 symbols constitute one sub-frame which is 0.5 ms in length. The particular symbol(s) of the sub-frame, e.g. the first symbol of the sub-frame, can be used for the PDCCH (Physical Downlink Control Channel). PDCCH channel carries L1 signaling.

A transport channel transfers signaling and data between L1 and MAC layers. A physical channel is mapped to a transport channel.

Downlink transport channel types are:

1. Broadcast Channel (BCH) used for transmitting system information

2. Downlink Shared Channel (DL-SCH) characterised by: support for HARQ; support for dynamic link adaptation by varying the modulation, coding and transmit power; possibility to be broadcast in the entire cell; possibility to use beamforming; support for both dynamic and semi-static resource allocation

3. Paging Channel (PCH) used for paging a UE

4. Multicast Channel (MCH) used for multicast or broadcast service transmission.

Uplink transport channel types are:

1. Uplink Shared Channel (UL-SCH) characterised by: possibility to use beamforming; (likely no impact on specifications); support for dynamic link adaptation by varying the transmit power and potentially modulation and coding; support for HARQ

2. Random Access Channel(s) (RACH) used normally for initial access to a cell.

The MAC sublayer provides data transfer services on logical channels. A set of logical channel types is defined for different kinds of data transfer services as offered by MAC. Each logical channel type is defined by what type of information is transferred.

A general classification of logical channels is into two groups:
Control Channels (for the transfer of control plane data);
Traffic Channels (for the transfer of user plane data).

Control channels are used for transfer of control plane data only. The control channels offered by MAC are:
Broadcast Control Channel (BCCH)

A downlink channel for broadcasting system control information
Paging Control Channel (PCCH)

A downlink channel that transfers paging information. This channel is used when the network does not know the location cell of the UE.
Common Control Channel (CCCH)

this channel is used by the UEs having no RRC connection with the network.
Multicast Control Channel (MCCH)

A point-to-multipoint downlink channel used for transmitting MBMS control data from the network to the UE.
Dedicated Control Channel (DCCH)

A point-to-point bi-directional channel that transmits dedicated control data between a UE and the network. Used by UEs having an RRC connection.

Traffic channels are used for the transfer of user plane data only. The traffic channels offered by MAC are:
Dedicated Traffic Channel (DTCH)

A Dedicated Traffic Channel (DTCH) is a point-to-point channel, dedicated to one UE, for the transfer of user data. A DTCH can exist in both uplink and downlink.
Multicast Traffic Channel (MTCH)

A point-to-multipoint downlink channel for transmitting traffic data from the network to the UE.

In Uplink, the following connections between logical channels and transport channels exist:
DCCH can be mapped to UL-SCH;
DTCH can be mapped to UL-SCH.

In Downlink, the following connections between logical channels and transport channels exist:
BCCH can be mapped to BCH;
PCCH can be mapped to PCH;
DCCH can be mapped to DL-SCH;
DTCH can be mapped to DL-SCH;
MCCH can be mapped to MCH;
MTCH can be mapped to MCH;

Conventionally, only one carrier (e.g. a frequency band) is used at a time with respect to a given UE for transporting data, such as useful data and/or control data.

But for supporting wider transmission bandwidths, it would be better to use carrier aggregation, that is simultaneous support of multiple carriers. Carrier aggregation would thus involve transporting data, such as useful data and/or control data, over a plurality of carriers with respect to a given UE. It would thus enhance the conventional carrier usage and be adapted to the multiple access type of the considered radio communication system.

As far as LTE is concerned, carrier aggregation has been introduced in a recent version thereof, so-called LTE-Advanced, which extends LTE Release 8 (LTE Rel-8). Some aspects of carrier aggregation are disclosed for example in 3GPP TR 36.814 V0.4.1, 3rd Generation Partnership Project; Technical Specification Group Radio Access Network; Further Advancements for E-UTRA Physical Layer Aspects (Release 9) released in February 2009 (see section 5 in particular), as well as in subsequent versions thereof. Other standard documents, which are well known by one skilled in the art, relate to other aspects of carrier aggregation.

Thus LTE-Advanced allows having two or more carriers, so-called component carriers (CCs), aggregated in order to support wider transmission bandwidths e.g. up to 100 MHz and for spectrum aggregation.

In contrast with an LTE Rel-8 terminal, an LTE-Advanced terminal with reception and/or transmission capabilities for carrier aggregation can simultaneously receive and/or transmit on multiple component carriers.

According to a non-limiting example, a carrier may be defined by a bandwidth and a center frequency. If five carriers are assigned as granularity of carrier unit having a 5 MHz bandwidth, carrier aggregation may lead to a bandwidth of a maximum of 20 MHz.

Contiguous spectrum aggregation and/or non-contiguous spectrum aggregation may take place. The contiguous spectrum aggregation uses contiguous carriers and the non-contiguous spectrum aggregation uses discontiguous carriers. The number of aggregated carriers may be different in uplink and downlink. When the number of downlink carriers and that of uplink carriers are equal, it is called a symmetric aggregation, and when the numbers are different, it is called an asymmetric aggregation.

The size (i.e., the bandwidth) of multiple carriers may vary. For example, when five carriers are used to configure a 70 MHz band, they may be configured as 5 MHz carrier (carrier #0)+20 MHz carrier (carrier #1)+20 MHz carrier (carrier #2)+20 MHz carrier (carrier #3)+5 MHz carrier (carrier #4).

FIG. 6 illustrates an example of a protocol structure for supporting multiple carriers. A common medium access control (MAC) entity 210 manages a physical (PHY) layer 220 which uses a plurality of carriers. A MAC management message transmitted by a particular carrier may be applied to other carriers. The PHY layer 220 may operate e.g. in a TDD (Time Division Duplex) and/or FDD (Frequency Division Duplex) scheme.

There are several physical control channels used in the physical layer 220. A physical downlink control channel (PDCCH) may inform the UE about the resource allocation of paging channel (PCH) and downlink shared channel (DL-SCH), and hybrid automatic repeat request (HARQ) information related to DL-SCH. The PDCCH may carry the uplink scheduling grant which informs the UE about resource allocation of uplink transmission. A physical control format indicator channel (PCFICH) informs the UE about the number of OFDM symbols used for the PDCCHs and is transmitted in every subframe. A physical Hybrid ARQ Indicator Channel (PHICH) carries HARQ ACK/NAK signals in response to uplink transmissions. A physical uplink control channel (PUCCH) carries uplink control data such as HARQ ACK/NAK in response to downlink transmission, scheduling request and channel quality indicator (CQI). A physical uplink shared channel (PUSCH) carries uplink shared channel (UL-SCH).

Each component carrier may have its own control channel, i.e. PDCCH. Alternatively, only some component carriers may have an associated PDCCH, while the other component carriers do not have their own PDCCH.

Component carriers may be divided into a primary component carrier (PCC) and one or several secondary component carriers (SCCs) depending on whether they are activated. A PCC refers to a component carrier that is constantly activated, and an SCC refers to a component carrier that is activated or deactivated according to particular conditions. Activation means that transmission or reception of traffic data is performed or traffic data is ready for its transmission or reception. Deactivation means that transmission or reception of traffic data is not permitted. In the deactivation, measurement is made or minimum information can be transmitted or received. The UE generally uses only a single PCC and possibly one or more SCCs along with the PCC.

A PCC is a component carrier used by a BS to exchange traffic and PHY/MAC control signaling (e.g. MAC control messages) with a UE. SCCs carriers are additional component carriers which the UE may use for traffic, only per BS's specific commands and rules received e.g. on the PCC. The PCC may be a fully configured carrier, by which major control data is exchanged between the BS and the UE. In particular, the PCC is configured with PDCCH. The SCC may be a fully configured component carrier or a partially configured component carrier, which is allocated according to a request of the UE or according to an instruction of the BS. The PCC may be used for entering of the UE into a network or for an allocation of the SCC. The primary carrier may be selected from among fully configured component carriers, rather than being fixed to a particular component carrier. A component carrier set as an SCC carrier may be changed to a PCC.

A PCC may further have at least some of the following characteristics:
to be in accordance with the definitions of the PCC introduced in Rel-10 CA;
uplink PCC and downlink PCC may be configured per UE;
uplink PCC may be used for transmission of L1 uplink control data;
downlink PCC cannot be de-activated;
re-establishment may be triggered when the downlink PCC experiences RLF (radio link failure), not when other downlink CC's experience RLF;
SI (system information) reception for the downlink PCC, Rel-8 procedures may apply;
this may not imply anything for the reception of the SI of other configured CC's;
NAS information may be taken from the downlink PCC cell.

When considering Carrier Aggregation (CA), a Secondary Component Carrier (SCC) activation/deactivation mechanism may be carried out in order to reduce the UE power consumption. In this case, a Primary Component Carrier (PCC) may carry an explicit activation/deactivation of configured DL secondary component carriers signalled e.g. by a MAC control element (MAC CE). For more details about MAC CEs, the reader can refer for example to the technical specification 3GPP TS 36.321 V8.8.0 (2009-12), 3rd Generation Partnership Project; Technical Specification Group Radio Access Network; Evolved Universal Terrestrial Radio Access (E-UTRA) Medium Access Control (MAC) protocol specification (Release 8).

### DISCLOSURE OF INVENTION

### Technical Problem

It has been noted by the inventors of the present invention that this activating/de-activating carrier aggregation may have impacts on the UE reception due to the need for radio frequency (RF) retuning when the UE effective Rx and/or Tx bandwidth is modified. For example, in an intra-band contiguous case, it would be necessary to configure the receiver to have wider reception bandwidth (e.g. change reception bandwidth from 20 MHz to 40 MHz) or in reverse to have narrower bandwidth (e.g. changing reception bandwidth from 40 MHz to 20 MHz). This would require UE to adjust the local oscillator (LO) position and reconfigure the baseband filters.

When the UE is performing RF retuning, it cannot receive scheduling transmissions on any of the activated DL SCCs in the same frequency band, as well as on the corresponding UL CCs. Moreover, the UE is not able to receive the DL HARQ ACK/NACK for a corresponding UL transmission happening just before RF retuning start.

Due to the fact that the eNB normally does not know when such RF retuning occurs, resource allocation in the corresponding time window will result in a loss of data.

To alleviate at least part of these drawbacks, the invention proposes some scheduling restrictions and/or UE behaviour rules.

### Solution to Problem

More specifically, the present invention proposes a method for transmitting data between a base station of a radiocommunication network and a User Equipment, UE, by using multiple Component Carriers, CCs. The method comprises:
transmitting, on a Primary CC, PCC, an activation/deactivation command to activate/deactivate a Secondary CC, SCC, from the base station to the UE;
after transmission of said activation/deactivation command, delaying transmission of data on the SCC between the base station and the UE by a predetermined delay, the predetermined delay being set to include a time period needed for a UE to perform an RF retuning as a result of an activation/deactivation command.

According to optional and advantageous features that may be combined in any possible manner:
an RF retuning resulting from said activation/deactivation command is delayed by the UE until an acknowledgement for the activation/deactivation command is transmitted from the UE to the base station, and said predetermined delay is set to further include a time period needed for a UE to acknowledge receipt of an activation/deactivation command; and/or
after transmission of said activation/deactivation command, transmission of data on the PCC between the base station and the UE is also delayed by said predetermined delay; and/or
an RF retuning resulting from said activation/deactivation command is delayed by the UE until all data pending on the PCC have been transmitted between the base station and the UE, and said predetermined delay is set to further include the time for all data pending on the PCC to be transmitted between the base station and the UE; and/or
transmitting the activation/deactivation command is delayed until all data pending on the PCC have been transmitted between the base station and the UE.

The invention also proposes a base station of a radiocommunication network capable of exchanging data with a User Equipment, UE, by using multiple Component Carriers, CCs. The base station comprises:
a transmission unit for transmitting to the UE, on a Primary CC, PCC, an activation/deactivation command to activate/deactivate a Secondary CC, SCC;
a data transmission delay unit for delaying transmission of data to the UE on the SCC by a predetermined delay after transmission of said activation/deactivation command, the predetermined delay being set to include a time period needed for a UE to perform an RF retuning as a result of an activation/deactivation command.

The invention also proposes a User Equipment, UE, capable of exchanging data with a base station of a radiocommunication network, by using multiple Component Carriers, CCs. The UE comprises:
a reception unit for receiving from the base station, on a Primary CC, PCC, an activation/deactivation command to activate/deactivate a Secondary CC, SCC;
a data transmission delay unit for delaying transmission of data to the base station on the SCC by a predetermined delay after transmission of said activation/deactivation command by the base station (and/or reception of activation/deactivation command by the UE), the predetermined delay being set to include a time period needed to perform an RF retuning as a result of an activation/deactivation command.

### Advantageous Effects of Invention

Such delay according to this invention reduces the risk that data may be lost because they are transmitted on SCC while the UE is still in the process of RF retuning.

### BRIEF DESCRIPTION OF DRAWINGS

FIG. 1 is a diagram showing an exemplary radiocommunication system;

FIG. 2 is a diagram showing an exemplary overview of an E-UTRAN architecture;

FIG. 3 is a diagram showing an exemplary user-plane protocol stack for E-UTRAN;

FIG. 4 is a diagram showing an exemplary control-plane protocol stack for E-UTRAN;

FIG. 5 is a diagram schematically showing a PDCCH channel arrangement;

FIG. 6 is a diagram showing an exemplary protocol structure for supporting multiple carriers (carrier aggregation);

FIG. 7 is a diagram showing a data transmission method between a base station of a radiocommunication network and a User Equipment according to a first non-limiting example;

FIG. 8 is a diagram showing a data transmission method between a base station of a radiocommunication network and a User Equipment according to a second non-limiting example;

FIG. 9 is a diagram showing an exemplary and non-limiting wireless communication system according to an embodiment of the present invention;

FIGS. 10 to 13 are diagrams showing data transmissions between a base station of a radiocommunication network and a User Equipment according to advantageous features in addition to the embodiments of FIGS. 7 and 8.

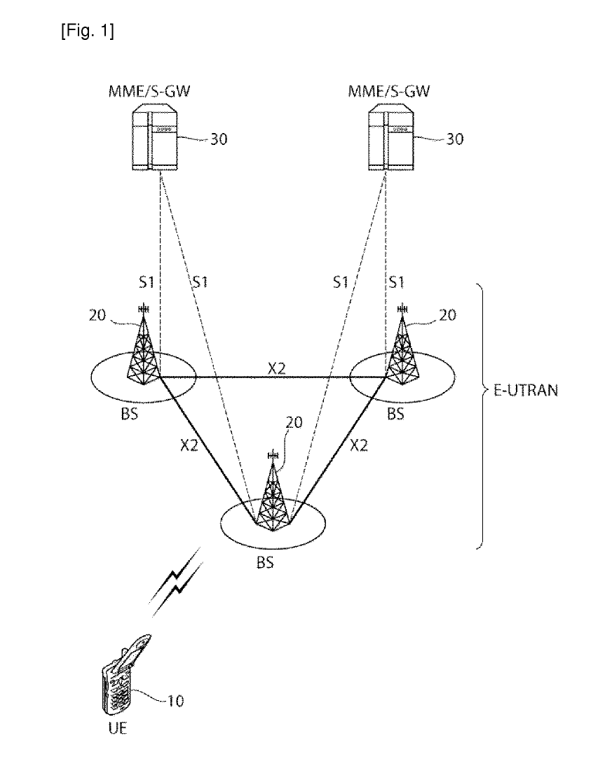

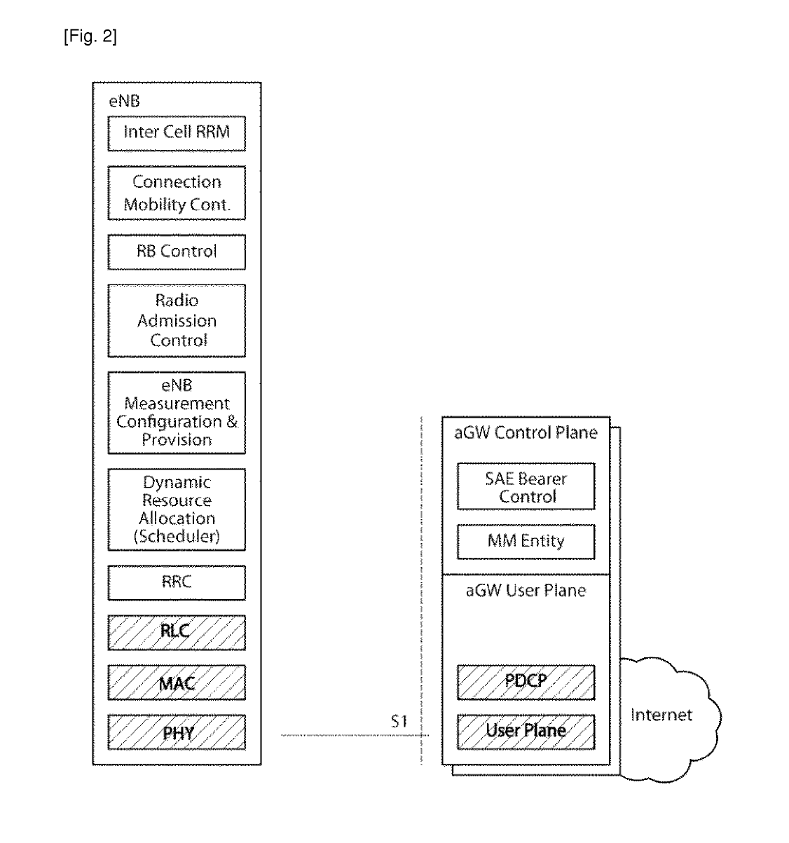

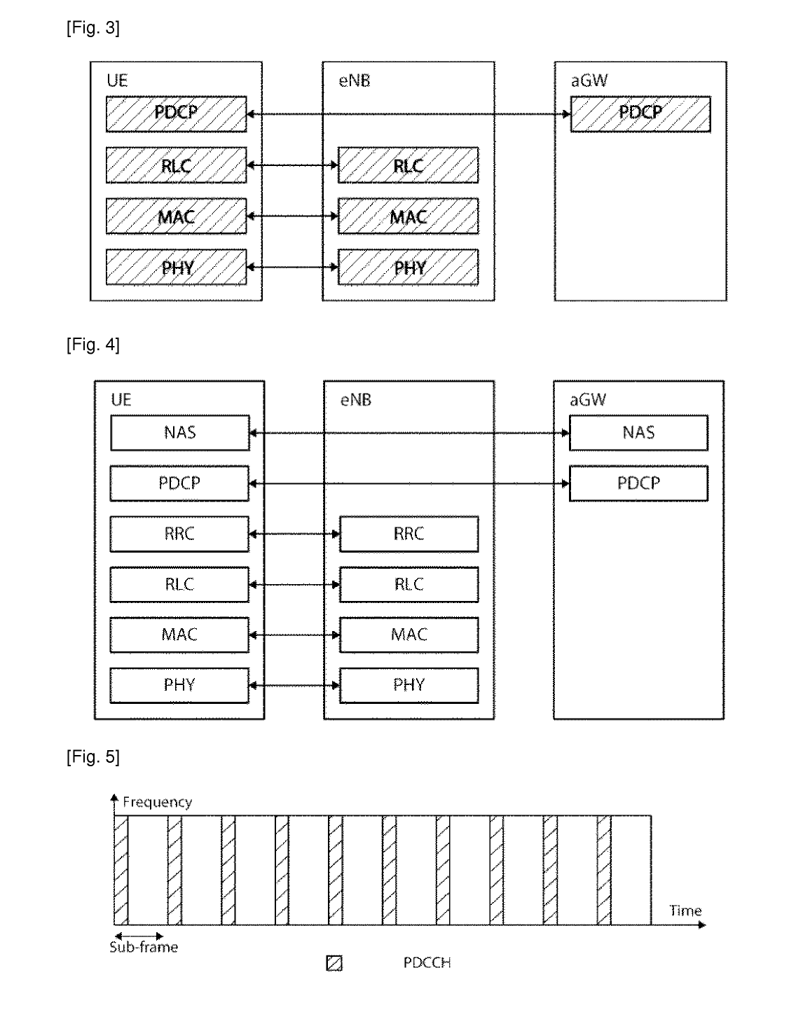

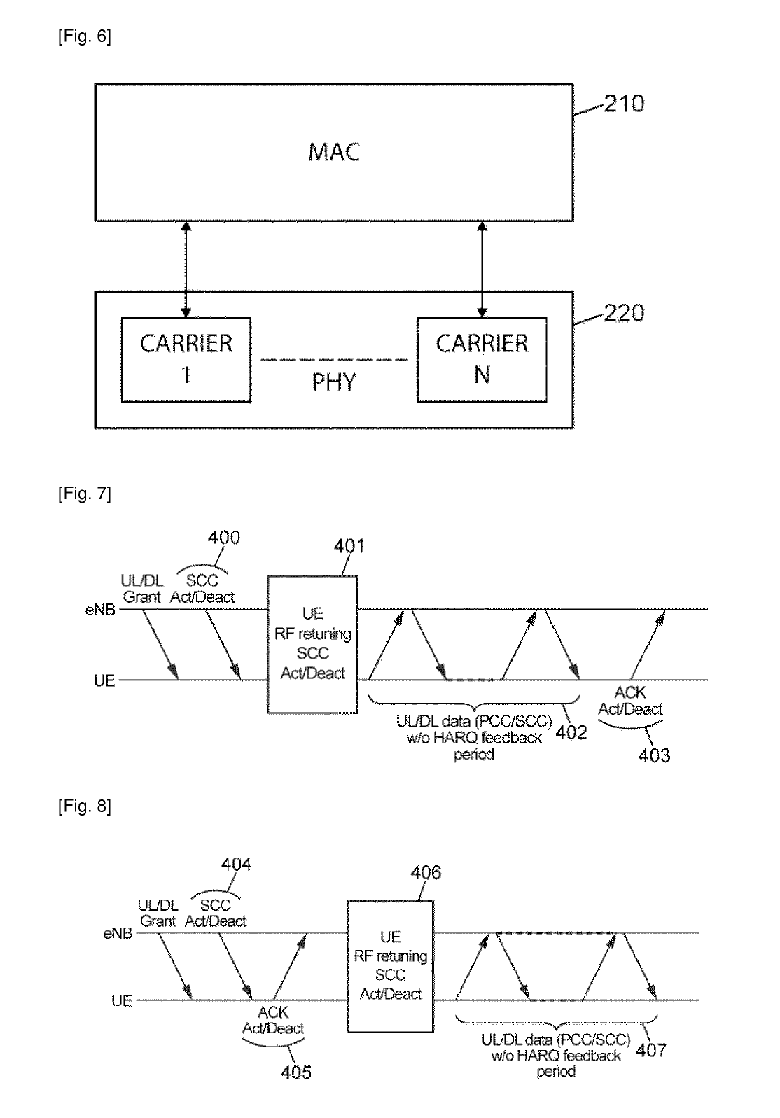

### BEST MODE FOR CARRYING OUT THE INVENTION

The invention will be described hereafter in the context of an LTE-A system supporting carrier aggregation as mentioned above. It applies however to any other type of system including at least one base station and at least one UE or equivalent, as will be apparent to one skilled in the art.

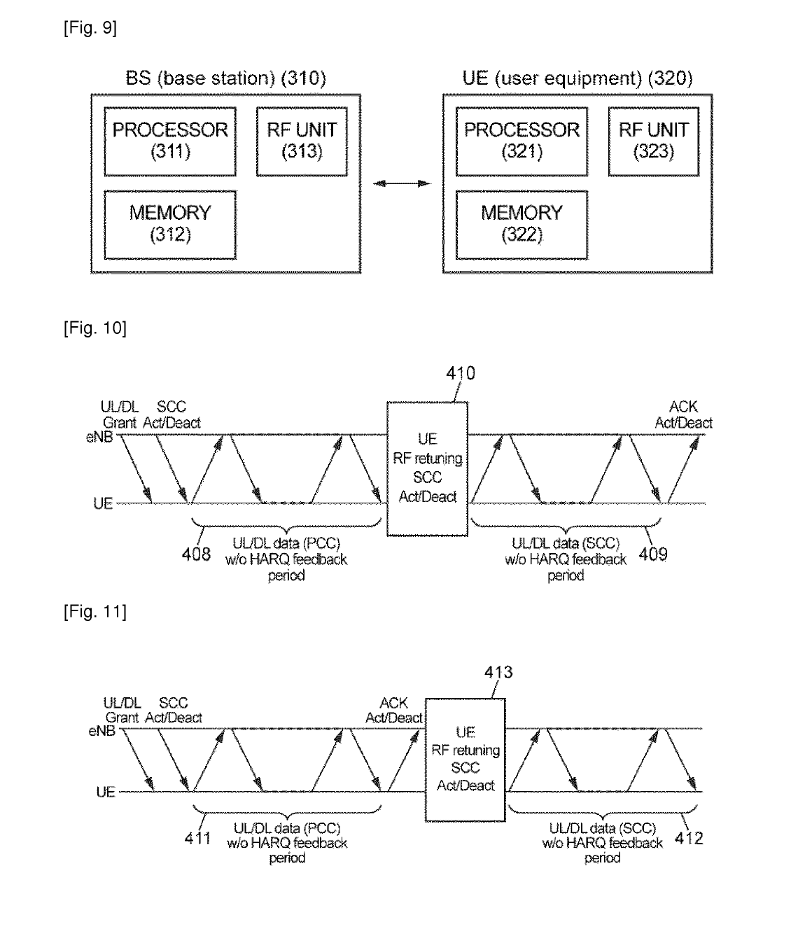

FIG. 9 shows an exemplary and non-limiting wireless communication system including a BS 310 and one or more UE(s) 320. In downlink, a transmitter may be a part of the BS 310, and a receiver may be a part of the UE 320. In uplink, a transmitter may be a part of the UE 320, and a receiver may be a part of the BS 310. The BS 310 may include a processor 311, a memory 312, and a radio frequency (RF) unit 313. The processor 311 may be configured to implement proposed procedures and/or methods described in the present document. In the exemplary system of FIG. 9, the memory 312 is coupled with the processor 311 and stores a variety of information to operate the processor 311. The RF unit 313 is coupled with the processor 311 and transmits and/or receives a radio signal.

The UE 320 may include a processor 321, a memory 322, and a RF unit 323. The processor 321 may be configured to implement proposed procedures and/or methods described in the present document. The memory 322 is coupled with the processor 321 and stores a variety of information to operate the processor 321. The RF unit 323 is coupled with the processor 321 and transmits and/or receives a radio signal.

The BS 310 and/or the UE 320 may have single antenna or multiple antennas. When at least one of the BS 310 and the UE 320 has multiple antennas, the wireless communication system may be called a multiple input multiple output (MIMO) system.

The BS 310 and the UE 320 support carrier aggregation, meaning that they may use multiple component carriers (CCs).

According to an aspect of the present invention, when using carrier aggregation, i.e. multiple CCs, between the BS 310 and the UE 320, an activation/deactivation command to activate/deactivate a Secondary CC (SCC) may be transmitted from the BS 310 to the UE 320 at some point in time. This activation/deactivation command may be transmitted e.g. on a Primary CC (PCC), for example by means of a MAC control element (MAC CE) as mentioned above.

After the transmission of that activation/deactivation command, transmission of data on the SCC between the base station and the UE is delayed by a predetermined delay set to include a time period needed for a UE to perform an RF retuning as a result of an activation/deactivation command.

The data transmission delayed may relate to uplink and/or downlink data (where the term “data” has a broad meaning, which covers in particular both user traffic and control information as already explained). It can for example relate to transmission of data on a PDSCH and/or a PUSCH configured on the considered SCC. Alternatively or in addition, it can also relate to resource scheduling assignments on the considered SCC, uplink and/or downlink HARQ ACK/NACK for a corresponding downlink and/or uplink transmission on the considered SCC, and/or other.

The delay is predetermined, as it is determined before being applied to the transmission of data on the SCC. It is set to include a time period needed for a UE to perform an RF retuning as a result of an activation/deactivation command. In other words, the predetermined delay equals or is longer than the time period needed for a UE to perform an RF retuning as a result of an activation/deactivation command.

This time period can be an average value for any type (or predetermined types) of UE in normal conditions (e.g. radio conditions, for example in terms of quality, level, interference, and/or other). In this case, the time period would advantageously be fixed.

Alternatively, the time period may be determined in a more dynamic way, for example by taking account of characteristics of the considered UE, instantaneous conditions (e.g. radio conditions, for example in terms of quality, level, interference, and/or other), and/or other.

When delaying the data transmission on the SCC is performed at least in part by the BS 310, the latter may rely on a predetermined delay already available in its memory. Although the same may apply to the UE 320, the latter may alternatively determine the predetermined delay by itself, possibly by taking account of the time it actually needs to perform an RF retuning.

One skilled in the art will understand that other possibilities may be envisaged for the determination of the predetermined delay.

By delaying transmission of data on the SCC, the probability that data transmission occurs while the UE 320 is performing RF tuning as a result of the received activation/deactivation command is lowered down. The resulting probability of data loss is thus reduced.

The predetermined delay may be set to start right after or some time after transmission of the activation/deactivation command. This suits particularly well for downlink data transmission initiated by the BS 310.

As far as the UE 320 is concerned, its uplink data transmission to the BS 310 on the SCC may be delayed by the predetermined delay starting after it has received the activation/deactivation command, rather than right after the transmission of the activation/deactivation command by the BS 310. Alternatively, even in this case, the predetermined delay may start immediately after transmission of the activation/deactivation command by the BS 310. In this case, the UE 320 may estimate the activation/deactivation command transmission time from the activation/deactivation command reception time, which it knows. Alternatively or in addition, the activation/deactivation command transmission time may be signaled to the UE 320 by the BS 310. Other possibilities may be envisaged alternatively or in addition, as will be apparent to one skilled in the art.

It can be noted that the activation/deactivation command mentioned above may be transmitted by a transmission unit of the BS 310 (which is part of the RF unit 313) and received by a reception unit of the UE 320 (which is part of the RF unit 323).

Also, a data transmission delay unit may be implemented in the BS 310 and/or in the UE 320 for delaying transmission of data on the SCC to the UE 320 and/or to the BS 310 respectively. Such unit may cooperate with or be part of the processor 311 and/or the processor 321 respectively.

The predetermined delay used for delaying transmission of data on the SCC may be stored in the memory 312 of the BS 310 and/or on the memory 322 of the UE 320.

A first example of the invention will now be described with reference to FIG. 7.

In this example, an eNB (which may be the BS 310) transmits to a UE (which may be the UE 320) an activation/deactivation command 400, noted SCC Act/Deact, to activate/deactivate a Secondary CC. This transmission is advantageously performed on a Primary CC. The activation/deactivation command 400 is carried for example in a MAC CE.

Upon receiving the SCC Act/Deact 400, the UE starts an RF retuning 401 implied by the SCC activation/deactivation.

As mentioned above, transmission of data on the SCC between the eNB and the UE is delayed by a predetermined delay. If the latter is correctly set and under regular conditions, no data transmission occurs on the SCC during the RF retuning 401 period. In this case, the first UL and/or DL data transmission 402 (with or without HARQ feedback) will occur after the end of the RF retuning 401 period.

In the example shown in FIG. 7, the eNB does not wait for the HARQ feedback, especially for an acknowledgement of the SCC Act/Deact 400, before actually scheduling data on that SCC. The reason may be that the activation/deactivation command is typically received correctly upon the first transmission attempt (e.g. depending of the HARQ BLEP target). In this case, the eNB may assume that the activation/deactivation command was received and start scheduling data. If it receives a NACK or DTX for the process carrying the activation/deactivation command, it knows that it has to retransmit the HARQ transport blocks sent already on the to-be-activated SCC. Otherwise if eNB receives an ACK for the scheduled data (or data on scheduled grant), the ACK of the activation/deactivation command might (or not) be omitted. On FIG. 7, an acknowledgement 403 for the SCC Act/Deact 400, noted ACK Act/Deact, appears after a few data transmission 402 has occurred on the SCC.

As the RF retuning will be UE implementation dependent and also the UE channel conditions may impact the correct reception upon first attempt of an activation/deactivation command in order to optimize the resources efficiency, it is advantageous to specify the timing relation between the transmission of the activation/deactivation command at time T and the time T+x at which the corresponding scheduling on that SCC is performed. The delay x will thus roughly represent the time during which the UE performs the RF retuning 401.

This may require that the eNB scheduler remembers that at time instant T it had commanded an SCC activation/deactivation and that therefore the corresponding UE cannot be scheduled for transmission during the next “x” times.

Advantages resulting from the first example shown in FIG. 7 include: a limitation of the delay since data transmission can take place on the SCC before the ACK Act/Deact 403 is received at the eNB; as well as the possibility of having asynchronous activation/deactivation acknowledgment.

However, this first example may also increase the length of scheduling gaps and/or reduce the resources efficiency.

A second example is shown on FIG. 8. Like in the above-mentioned first example, data transmission 407 on the SCC is delayed by a predetermined delay set to include a time period needed to perform an RF retuning as a result of an activation/deactivation command (such as the RF retuning 406).

The main difference is that, in the second example, the RF retuning 406 resulting from the SCC Act/Deact 404 is delayed by the UE until an acknowledgement for the SCC Act/Deact 404, namely the ACK Act/Deact 405, is transmitted from the UE to the eNB. So the RF retuning of the UE does not start immediately after the activation/deactivation command is sent by the eNB or is received by the UE, but only after transmission of the positive acknowledgement HARQ feedback. This may reduce the length of scheduling gaps.

In this case, the above-mentioned predetermined delay is set to include not only a time period needed for a UE to perform an RF retuning as a result of an activation/deactivation command, but also a time period needed for a UE to acknowledge receipt of an activation/deactivation command. In other words, the delay before allowing data transmission 407 on the SCC after the activation/deactivation command 404 is extended to give sufficient time for the UE to acknowledge receipt of an activation/deactivation command (405) and perform an RF retuning 406.

The UE transmission power may be centred on the middle of CC frequency. So when SCC is added or removed, the UE may need to centre the transmission power to the new frequency.

In FIGS. 7 and 8 relating to the first and second examples respectively, it is shown that, after transmission of said activation/deactivation command, not only data transmission on the SCC but also data transmission on the PCC between the UE and the eNB is delayed by the same predetermined delay (see references 402 and 407). As a variant, both data transmissions on the SCC and on the PCC may be delayed, but with different predetermined delays.

This may introduce additional interference level. In order to optimize the level of interference, an alternative is that only data transmission on the SCC may be delayed. For example, only SCC scheduling would be delayed, the scheduling on the PCC being performed without delay and thus beforehand.

This situation is illustrated in FIG. 10 with respect to the first example and in FIG. 11 with respect to the second example. Data transmission 408 or 411 on the PCC occurs before the UE RF retuning 410 or 413, while data transmission 409 or 412 on the SCC is deferred so as to take place advantageously after the end of the UE RF retuning 410 or 413.

Advantageously, the RF retuning resulting from the activation/deactivation command may be delayed by the UE until all data pending on the PCC have been transmitted between the eNB and the UE. In this case, the above-mentioned predetermined delay may be set to further include the time for all data pending on the PCC to be transmitted between the base station and the UE. This may further increase the delay before data transmission takes place on the SCC.

Alternatively or in addition, the transmission of the activation/deactivation command may be delayed until all data pending on the PCC have been transmitted between the eNB and the UE.

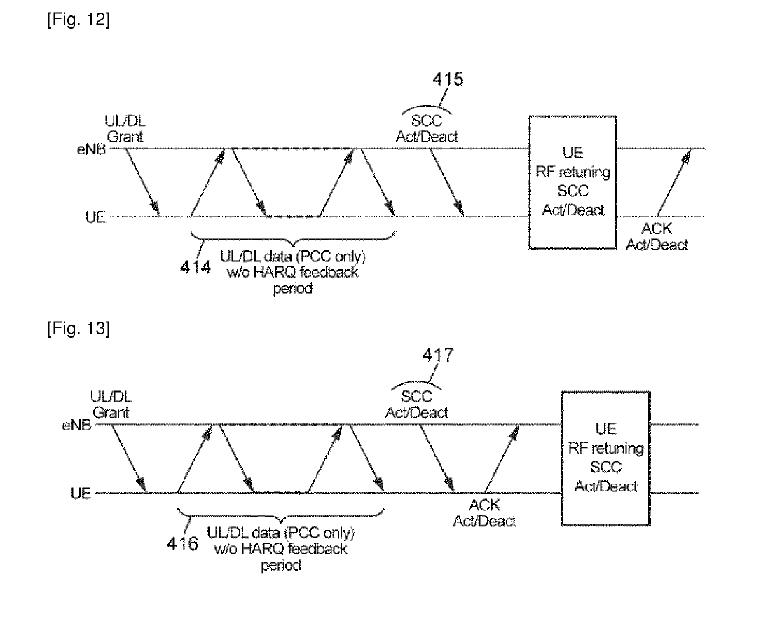

For example, as shown in FIG. 12 with respect to the first example and in FIG. 13 with respect to the second example, the eNB may send an SCC Act/Deact command 415 or 417 without scheduling data pending on PCC, i.e. only after data transmission 414 or 416 has been completed on the PCC.

### INDUSTRIAL APPLICABILITY

Other embodiments may be envisaged within the framework of the present invention, as will be apparent to one skilled in the art.

1. A method for transmitting data between a base station of a radio_communication network and a User Equipment, UE, by using multiple Component Carriers, CCs, the method comprising:
transmitting, on a Primary CC, PCC, an activation/deactivation command to activate/deactivate a Secondary CC, SCC, from the base station to the UE;
after transmission of said activation/deactivation command, delaying transmission of data on the SCC between the base station and the UE by a predetermined delay, the predetermined delay being set to include a time period needed for a UE to perform an RF retuning as a result of an activation/deactivation command.

2. The method as claimed in claim 1, wherein an RF retuning resulting from said activation/deactivation command is delayed by the UE until an acknowledgement for the activation/deactivation command is transmitted from the UE to the base station, and wherein said predetermined delay is set to further include a time period needed for a UE to acknowledge receipt of an activation/deactivation command.

3. The method as claimed in claim 1, wherein after transmission of said activation/deactivation command, transmission of data on the PCC between the base station and the UE is also delayed by said predetermined delay.

4. The method as claimed in claim 1, wherein an RF retuning resulting from said activation/deactivation command is delayed by the UE until all data pending on the PCC have been transmitted between the base station and the UE, and wherein said predetermined delay is set to further include the time for all data pending on the PCC to be transmitted between the base station and the UE.

5. The method as claimed in claim 1, wherein transmitting the activation/deactivation command is delayed until all data pending on the PCC have been transmitted between the base station and the UE.

6. A base station of a radio_communication network capable of exchanging data with a User Equipment, UE, by using multiple Component Carriers, CCs, the base station comprising:
a transmission unit for transmitting to the UE, on a Primary CC, PCC, an activation/deactivation command to activate/deactivate a Secondary CC, SCC;
a data transmission delay unit for delaying transmission of data to the UE on the SCC by a predetermined delay after transmission of said activation/deactivation command, the predetermined delay being set to include a time period needed for a UE to perform an RF retuning as a result of an activation/deactivation command.

7. The base station as claimed in claim 6, wherein said predetermined delay is set to further include a time period needed for a UE to acknowledge receipt of an activation/deactivation command.

8. The base station as claimed in claim 6, further comprising a data transmission delay unit for delaying transmission of data to the UE on the PCC by said predetermined delay.

9. The base station as claimed in claim 6, wherein said predetermined delay is set to further include the time for all data pending on the PCC to be transmitted to the UE.

10. The base station as claimed in claims 6, further comprising an activation/deactivation command transmission delay unit for delaying the activation/deactivation command until all data pending on the PCC have been transmitted to the UE.

11. A User Equipment, UE, capable of exchanging data with a base station of a radio_communication network, by using multiple Component Carriers, CCs, the UE comprising:
a reception unit for receiving from the base station, on a Primary CC, PCC, an activation/deactivation command to activate/deactivate a Secondary CC, SCC;
a data transmission delay unit for delaying transmission of data to the base station on the SCC by a predetermined delay after transmission of said activation/deactivation command by the base station, the predetermined delay being set to include a time period needed to perform an RF retuning as a result of an activation/deactivation command.

12. The UE as claimed in claim 11, further comprising an RF retuning delay unit for delaying RF retuning resulting from said activation/deactivation command until an acknowledgement for the activation/deactivation command is transmitted to the base station, said predetermined delay being set to further include a time period needed to acknowledge receipt of an activation/deactivation command.

13. The UE as claimed in claim 11, further comprising a data transmission delay unit for delaying transmission of data to the base station on the PCC by said predetermined delay.

14. The UE as claimed in claim 11, further comprising an RF retuning delay unit for delaying RF retuning resulting from said activation/deactivation command until all data pending on the PCC have been transmitted to the base station.
